(19) United States
(12) Patent Application Publication
(10) Pub. No.: US 2015/0022336 A1
(43) Pub. Date: Jan. 22, 2015

(54) DEVICE FOR CONTROLLING A TURN SIGNAL

(71) Applicant: GM GLOBAL TECHNOLOGY OPERATIONS LLC, Detroit, MI (US)

(72) Inventor: Timo Mueller, Limburg (DE)

(21) Appl. No.: 14/338,239

(22) Filed: Jul. 22, 2014

(30) Foreign Application Priority Data
Jul. 22, 2013 (DE) 102013012181.7

(51) Int. Cl. B60Q 1/34; B60R 1/00

(52) U.S. Cl. CPC B60Q 1/34; B60R 1/00; B60R 2300/8086
USPC 340/477; 340/476

(57) ABSTRACT

A system for controlling a turn signal for a motor vehicle is disclosed to detect lane changes of the motor vehicle. The system includes a control device which acquires information provided by an environment sensor, and controls the turn signal as a function of a lane change status.

### CROSS REFERENCE TO RELATED APPLICATION

This application claims priority to German Patent Application No. 102013012181.7 filed Jul. 22, 2013, which is incorporated herein by reference in its entirety.

### TECHNICAL FIELD

The technical field relates to a device for controlling a turn signal for a motor vehicle.

### BACKGROUND

Generally referred to as a blinker, the turn signal in a motor vehicle is usually controlled by moving a turn signal lever into an operating position. Two possible operations are here normally available. If the turn signal lever is moved into a locked-in position, the blinker stays on until the steering wheel has returned to the straight-ahead position after taking a curve in the direction indicated by the blinker. If the turn signal lever is touched lightly and released before reaching a locked in position, only a short-term blinking period lasting for about five blinking signals is initiated. In driving maneuvers, such as lane changes, the turn signal lever may not be moved to the locked-in position by the driver, since the driving maneuver will be largely over by the end of the few blinking signals, or the steering wheel is turned so slightly for the lane change that subsequently returning the steering wheel back to the straight-ahead position does not stop the blinking initiated from the locked-in position. In practice, however, the driving maneuver is often delayed, for example since a vehicle that is alongside or passing must first be let by before the lane change. The short-term blinking period then often ends before the driving maneuver is initiated. If the lane change is effected without blinking again, other road users may not have observed the initial blinking period. A blinker is often actuated long before a freeway exit ramp. If this happens without locking-in the turn signal lever, the lane change here most often also takes place after the short-term blinking period.

DE 199 36 171 A1 describes a control for a blinker in which the turn signal lever initiates a number of blinking signals fixed as a function of various parameters when not in the locked-in position by means of an electric or electronic control device. For example, blinking takes place three times at low speeds, and five times at higher speeds. In like manner, the higher number of blinking signals is initiated given poor visibility or a planned passing maneuver. By comparison to solutions in which a short-term blinking period of five blinking signals is initiated without locking-in the turn signal lever, there is no safety advantage with respect to the problem of delayed lane changes. The blinking process can here also end before a lane change has begun.

If the turn signal lever is moved into the locked-in position before driving maneuvers like lane changes, the driver has to manually return the turn signal lever at the end of the driving maneuver. This action is easy to forget, and may require additional prompting to end the blinking signal.

### SUMMARY

The present disclosure provides a device for controlling a turn signal in which the blinking process is adjusted to the traffic and driving maneuver in such a way as to elevate traffic safety and permit easy operation. The device is set up to detect lane changes of the motor vehicle based on information provided by the environment sensor, and deactivate the turn signal upon detection of a lane change to control the turn signal for a motor vehicle and includes an environment sensor and a control device.

The environment sensor preferably detects a lane change based on road markings, and relays this information to the control device. Examples of road markings include the white (or yellow) long markings (solid or dashed lines) that border the lanes. The environment sensor can also be an optical sensor, in particular a camera.

The control device or controller includes a first timer that deactivates the turn signal if no lane change takes place after a first prescribed period. This prevents the turn signal from staying on continuously if the turn signal is inadvertently activated or the intended lane change is aborted. The control device may also include a monitoring unit to evaluate the possibility of a lane change and block the timer if a lane change is deemed not possible. This ensures that the turn signal is not deactivated until the driver has at least had the chance to do what he or she intended. A second timer may be provided to deactivate the turn signal depending on the potential impossibility of a lane change after a second prescribed period. For example, this prevents the turn signal from remaining on continuously if the intended lane change is aborted.

The monitoring unit is configured in one embodiment to deem a lane change as not possible if a target lane is occupied by another vehicle. The target lane is to be understood as the lane next to the current lane to which the turn signal is blinking. The monitoring unit is configured up in another embodiment to detect traffic signs and deem a lane change as not possible based on the information content of the detected traffic sign, e.g., a no passing sign. The monitoring unit is further configured in another embodiment to deem a lane change as not possible if a road marking does not allow a change to the target lane. The monitoring unit is further configured in another embodiment to deem a lane change as not possible if there is no target lane on the side being blinked to. For example, this will typically be the case when putting a blinker on to veer into a turn lane before reaching the turn lane. In another embodiment, the monitoring device is configured to check whether the target lane is present based on data from a navigation system.

The present disclosure also provides a method for controlling a turn signal in a motor vehicle including manually activating a turn signal, determining whether the motor vehicle is making a lane change based on information from an environment sensor, and deactivating the turn signal upon detection of a lane change. The present disclosure provides a computer program product that encompasses instructions which when implemented on a computer operate as a control device and as a monitoring unit in a device as described above, or implement the method described above. The computer program product may be embodied in a non-transitory computer-readable medium with a recorded program instructions that allow a computer to work in the way indicated.

### BRIEF DESCRIPTION OF THE DRAWINGS

The present disclosure will hereinafter be described in conjunction with the following drawing figures, wherein like numerals denote like elements.

FIG. 1 is a schematic view of a motor vehicle from above with the device for controlling a turn signal; and

FIG. 2 is a schematic view depicting how the turn signal is controlled based on a block diagram.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

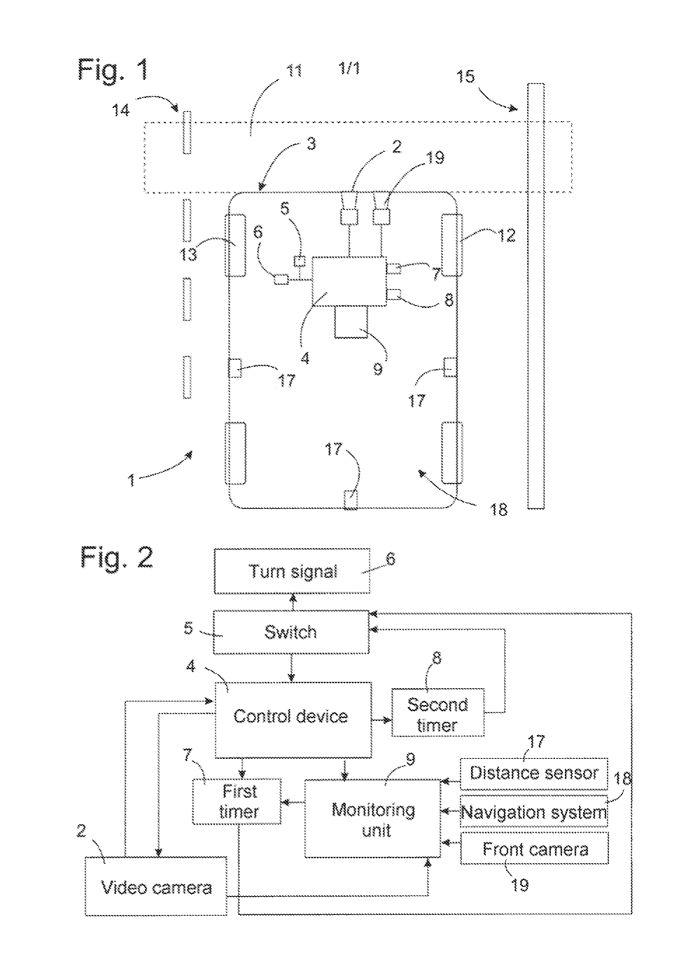

FIG. 1 shows a schematic view from above of a motor vehicle with a digital video camera 2 as the environment sensor and a control device 4 connected to the video camera 2. A turn signal 6 can be switched by the control device 4 and manually by the driver via a switch 5. The video camera 2 can be located at the front of the vehicle 3, logically in the front bumper, so as to detect the lane in front of the motor vehicle 1 along with markings on its edges. Alternately, two cameras spatially-oriented toward lane markings to the right and left of the vehicle 1 can also be provided on the respective flanks of the vehicle 1.

FIG. 2 schematically depicts control of the turn signal on a block diagram. If the turn signal 6 is actuated on the switch 5, the control device 4 activates a first timer 7, a second timer 8 and a monitoring unit 9. If the camera 2 is used exclusively within the framework of the present disclosure to control the turn signal 6, it may also be activated by actuating the switch 5. In a preferred modification, the camera and an image evaluation unit associated therewith may be components of a lane departure warning system, and continuously active in this function. The switch 5 is most preferably activated by briefly moving a turn signal lever (not shown) into a non-locked-in position.

The video camera 2 delivers images of a detection region 11 that spans the lane in front and to the sides of the motor vehicle 1 to the image evaluation unit. As known for lane departure systems, the latter determines the position of the vehicle 1 relative to the lane markings shown in the images, in particular long markings like dashed lines 14 or solid lines 15, and relays this information to the control device 4. The image evaluation unit can be implemented with the control device 4 on a shared processor.

When the driver actuates the switch 5 to indicate an intended lane change, e.g., to the left onto a passing lane, the turn signal 6 is activated, and the first and second timers 7, 8 are started. If the control device 4 detects that first a left front wheel 12 and then a right front wheel 13 have passed the lane marking 14 based on images from the camera 2, it can be concluded that the signaled lane change has taken place. In this case, the control device 4 deactivates the turn signal again. The expiration of set wait times t₁ and t₂ on the timers 7, 8 also prompts the control device 4 to deactivate the turn signal.

When the lane change has begun, i.e., once it has been detected that the left front wheel 12 has crossed over the lane marking 14, it can be provided that the control device 4 block or pause the first timer 7, so that wait time t₁ cannot elapse during the lane change. As a consequence, the turn signal 6 reliably blinks for the entire lane change, regardless of whether it is performed quickly or slowly. The wait time t₂ of the still running second timer 8 is significantly longer than the duration of a normal lane change. Deactivating the turn signal 6 after this wait time has expired ensures that blinking will end even given a failure to detect the right front wheel 13 crossing the marking 14, for example because it was interrupted or poorly visible.

The monitoring unit 9 can also be implemented with the control device 4 on the same processor. It is connected with sensors for gathering information about the environment of the vehicle 1. The sensors may include one or more of the following: distance sensors 17, a front camera 19, which can be identical to the video camera 2, and a GPS-supported navigation device 18. Once the turn signal 6 has been activated, the monitoring device scans the information from the sensors to determine whether a lane change is possible. If the monitoring device deems that a lane change is not possible, the first timer 7 is blocked, so that the wait time t₁ cannot run. The turn signal 6 remains on. As a result, the turn signal remains activated if a lane change is delayed until the control device 4 has detected the completion of the lane change.

The navigation system 18 determines the position of the motor vehicle 1 in relation to the course of the road i.e., roadmap data. The monitoring unit 9 determines whether a lane change is possible based on the sensor information and the roadmap data. A lane change is deemed as not possible if the roadmap data reveals that no other lane is present on the side indicated by the signaled lane change.

As denoted on FIG. 1, the distance sensors are secured to the motor vehicle on the sides and in the rear area, logically in the rear bumper. The distance sensors can be configured as radar, infrared or optical sensors. Their detection range is designed so as to encompass vehicles that occupy the target lane which primarily involve vehicles located next to or a slight distance behind the motor vehicle in the target lane. If data from the distance sensors 17 indicate to the monitoring unit that a vehicle is in the target lane, the lane change is deemed as not possible.

The front camera 19 is built into the vehicle so that it can detect traffic signs on a predetermined side of the road. Images of traffic signs that may be relevant in determining the possibility of a lane change are stored in an image processing unit integrated into the monitoring unit. If the image processing unit identifies a no passing sign, changing to a passing lane is not permissible. For example, if a sign indicating the distance to the next exit is identified, it may be inferred from this that changing to a turn-off lane for this exit is currently not possible, but may soon be possible.

Images of the roadway taken by the video camera 2 are compared with reference images of the roadway in the image processing unit integrated into the monitoring unit. Images of lane markings that do not allow a lane change, for example a solid line, or of roadsides are stored as reference images. If a video camera image and reference image match, the monitoring unit deems a lane change to be not possible.

The first timer 7 is blocked for as long as the lane change is determined to be bot possible, while the second timer 8 continues to run, and deactivates the turn signal 6 after the second wait time t₂, which is significantly longer than t₁. This timing ensures that the turn signal 6 is deactivated once again if an intended lane change is aborted due to a lengthy delay, or the turn signal was inadvertently activated.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-14. (canceled)

15. A device for controlling a turn signal for a motor vehicle comprising:
an environment sensor configured to acquire lane change information for a signaled lane change; and
a control device configured to detect a lane change of the motor vehicle based on the lane change information, and configured to deactivate a turn signal upon detection of a lane change.

16. The device for controlling a turn signal according to claim 15, wherein the environment sensor is configured to acquire the lane change information based on a road marking proximate to the motor vehicles in the direction of the signaled lane change, and to relay the lane change information to the control device.

17. The device for controlling a turn signal according to claim 15 wherein the environment sensor comprises an optical sensor.

18. The device for controlling a turn signal according to claim 17 wherein the environment sensor comprises a camera.

19. The device for controlling a turn signal according to claim 15 wherein the control device comprises a first timer configured to deactivate the turn signal when the lane change information indicates that no lane change has taken place after a first prescribed time period.

20. The device for controlling a turn signal according to claim 19, further comprising a monitoring unit configured to evaluate the possibility of a lane change in the direction of a signaled lane change and to block the first timer when a lane change is deemed not permissible or not possible.

21. The device for controlling a turn signal according to claim 20, wherein the environment sensor is configured to acquire target lane information for the signaled lane change, and wherein the monitoring unit is configured to deem a lane change as not possible when the target lane information indicates a target lane is occupied by another vehicle.

22. The device for controlling a turn signal according to claim 20, wherein the environment sensor is configured to acquire traffic sign information for the signaled lane change, and the monitoring unit is to deem a lane change as not permissible when the traffic sign information indicates that a lane change is not permissible.

23. The device for controlling a turn signal according to one of claims 22, wherein the environment sensor is configured to acquire road marking information for the signaled lane change, and the monitoring unit is configured to deem a lane change as not permissible when the road marking does not permit a lane change to the target lane.

24. The device for controlling a turn signal according to one of claims 20, wherein the monitoring unit is configured to deem a lane change as not possible when roadmap data indicates that a target lane is not present on the side indicated by the signaled lane change.

25. The device for controlling a turn signal according to claim 24, further comprising a navigation system for the motor vehicle, wherein the roadmap date is acquired from the navigation system.

26. The device for controlling a turn signal according to one of claims 19 further comprising a second timer configured to deactivate the turn signal when the signaled lane change is not completed after a second prescribed time period.

27. A computer program product comprising instructions executed on a computer operating the system according to claim 15.

28. A method for controlling a turn signal of a motor vehicle comprising:
manually activating a turn signal for a signaled lane change;
acquiring lane change information for the signaled lane change with an environment sensor;
detecting a lane change of the motor vehicle based on the lane change information;
deactivating the turn signal upon completion of the lane change based on the lane change information.

29. A non-transitory computer-readable medium comprising recorded program instructions configured to instruct a computer for executing the method according to claim 28.
